(19) United States
(12) Patent Application Publication
(10) Pub. No.: US 2008/0238012 A1
(43) Pub. Date: Oct. 2, 2008

(54) GARDEN WAGON

(76) Inventor: Mark C. Carter, Murieta, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/061,588

(22) Filed: Apr. 2, 2008

Related U.S. Application Data
(60) Provisional application No. 60/921,352, filed on Apr. 2, 2007.

(51) Int. Cl. B62B 3/10

(52) U.S. Cl. 280/47.35

(57) ABSTRACT

The garden wagon includes a main body, front and rear pairs of wheels rotatably mounted to the bottom of body, and a top shelf and a bottom shelf mounted to a frame assembly on the main body of the garden wagon. The top and bottom shelves include a plurality of corresponding apertures and slots that are aligned vertically for receiving tools. The garden wagon includes a trash bag holder, and may include a sun umbrella.

### CROSS-REFERENCE TO RELATED APPLICATIONS

This application is based upon Provisional Application No. 60/921,352, filed 2 Apr. 2007.

### BACKGROUND OF THE INVENTION

The present invention relates to a garden wagon, and more particularly relates to a multipurpose garden wagon for storage and transport gardening tools, equipment and supplies.

A common wagon used in gardening typically includes a main body with a pan for holding and transporting materials and equipment, four wheels and a front handle mounted to the main body so that the wagon can be pulled or pushed as desired.

A multiple-shelf wagon for storage and transport is also known that includes four tubular feet having four wheels and three rectangular shelves or baskets, with two lower baskets attached to and supported by the four tubular feet, and a top basket supported by only two of the four tubular feet. Another known design for a garden wagon includes a wheel frame with multiple compartments, two rear wheels and two smaller front wheels, and a folding top with a handle for pulling the wagon.

There is a need for a more versatile, multipurpose garden to aid the do-it-yourself gardener in storing and transporting gardening tools, equipment and supplies, that can also provide additional utility such as adjustable shade, folding trays, and a trash bag attachment. The present invention fulfills these and other needs.

### SUMMARY OF THE INVENTION

Briefly, and in general terms, the present invention provides for a garden wagon including a generally rectangular main body, front and rear pairs of wheels rotatably mounted to the main body, a top shelf and a bottom shelf mounted to a frame on the main body of the garden wagon.

In a first preferred embodiment, the present invention accordingly provides for a garden wagon including a generally rectangular main body, having a bottom, front and rear portions, left right lateral sides, front and rear pairs of wheels rotatably mounted to the bottom of the garden wagon; a front pull bar with a handle connected to the front of the main body; a pair of front posts and a pair of rear posts mounted at the rear portion of the bottom of the garden wagon, the front and rear pairs of posts including upper end portions; a generally rectangular rear top shelf including four tubular corner slots received and supported on the upper end portions of the front and rear pairs of posts; and a generally rectangular rear bottom shelf disposed on the rear portion of the bottom of the garden wagon. At least one folding tray may be pivotally mounted to the front posts. A trash bag holder may also be mounted to upper portions of the rear posts of the garden wagon. A sun umbrella may also be mounted to the upper end portion of one of the tubular posts.

In a presently preferred aspect, an upper folding tray and a lower folding tray are provided. Each folding tray includes a rectangular top support surface pivotally mounted to the front posts, and at least one folding truss support arm. The truss support arm includes an upper link and a lower link pivotally connected together, with the top end of the upper link pivotally connected to a front portion of the tray, and the lower end of the lower link pivotally connected to one of the front posts, so that the upper and lower links of the support arm are movable between an extended configuration supporting the folding tray horizontally and a collapsed, folded configuration in which the folding tray is folded down.

In another aspect, the rear top and bottom shelves also include a plurality of corresponding apertures and slots that are aligned vertically for receiving tools. In another aspect, the trash bag holder includes a lower hoop fixedly mounted to the upper portions of the rear posts, and a slightly larger pivoting hoop pivotally mounted to the upper portions of the rear posts. The larger pivoting hoop is movable between a raised position extending above the lower hoop and a lowered position extending adjacent to and in close proximity to the lower hoop. In another preferred aspect, the sun umbrella includes an adjustable swivel or pivot mounting with a control handle for moving the shade portion between an elevated, generally upright position and a lowered position.

In a second presently preferred embodiment, the invention provides for a garden wagon including a generally rectangular main body having front and rear pairs of wheels rotatably mounted to the bottom of the garden wagon, and a modular upper frame assembly removably disposed on the upper surface of the main body. In one presently preferred aspect, the main body includes a pull bar slidably and pivotally connected to one end of the main body, although in one variation, the main body may include a rearwardly directed handle connected to the main body for pushing the garden wagon.

In a presently preferred aspect, the modular upper frame assembly includes a frame of interconnected elongated members, a top shelf, and a bottom shelf, with the top shelf and bottom shelf connected together by the frame of interconnected elongated members. In another aspect, the frame of interconnected elongated members includes a pair of left and right side generally vertical elongated support brace posts and a rearwardly directed pair of left and right side elongated handle posts. The left and right side generally vertical elongated support brace posts have upper ends and bottom ends, and the bottom ends of the left and right side generally vertical elongated support brace posts are mounted to the left and right lateral sides of the bottom shelf at the rear side of the bottom shelf. The rearwardly directed pair of left and right side elongated handle posts are mounted to left and right lateral sides of the bottom shelf at the front side of the bottom shelf, and the rearwardly directed pair of left and right side elongated handle posts are connected to the upper ends of the left and right side generally vertical elongated support brace posts. The rearwardly directed pair of left and right side elongated handle posts have upper ends connected together by a transverse handle member.

In another presently preferred aspect, the top and bottom shelves include a plurality of corresponding apertures and slots that are aligned vertically with each other for receiving tools. In a further aspect, the top shelf may include a trash bag holder assembly.

These and other forms of the invention will become apparent from a consideration of the following detailed description and from the accompanying drawings.

### BRIEF DESCRIPTION OF THE DRAWINGS

FIG. 1 is a perspective view of a first embodiment of the garden wagon of the invention, showing the umbrella in a generally upright position.

FIG. 2 is a partial rear view of the trash bag holder of FIG. 1.

FIG. 3 is an enlarged view of a rear portion of the garden wagon of FIG. 1.

FIG. 4 is a perspective view of the garden wagon of FIG. 1, showing rotation of the umbrella in one direction.

FIG. 5 is a perspective view of the garden wagon of FIG. 1, showing rotation of the umbrella in another direction.

FIG. 6 is a perspective view of a second embodiment of the garden wagon of the invention, showing the main body with the front handle in an extended position.

FIG. 7 is a perspective view of a variation of the garden wagon of FIG. 6, showing the main body with a rearwardly directed handle for pushing the garden wagon.

FIG. 8 is a perspective view of a modular upper frame assembly including a handle and portions for holding garden tools and a trash bag.

FIG. 9 is a perspective view of the combination of the modular upper frame assembly and main body of the garden wagon, with the modular upper frame assembly of FIG. 8 placed on the upper surface of the main body of the garden wagon of FIG. 1.

FIG. 10 is a front perspective view of the combination of the modular upper frame assembly and main body of the garden wagon of FIG. 9.

### DETAILED DESCRIPTION OF THE PREFERRED EMBODIMENTS

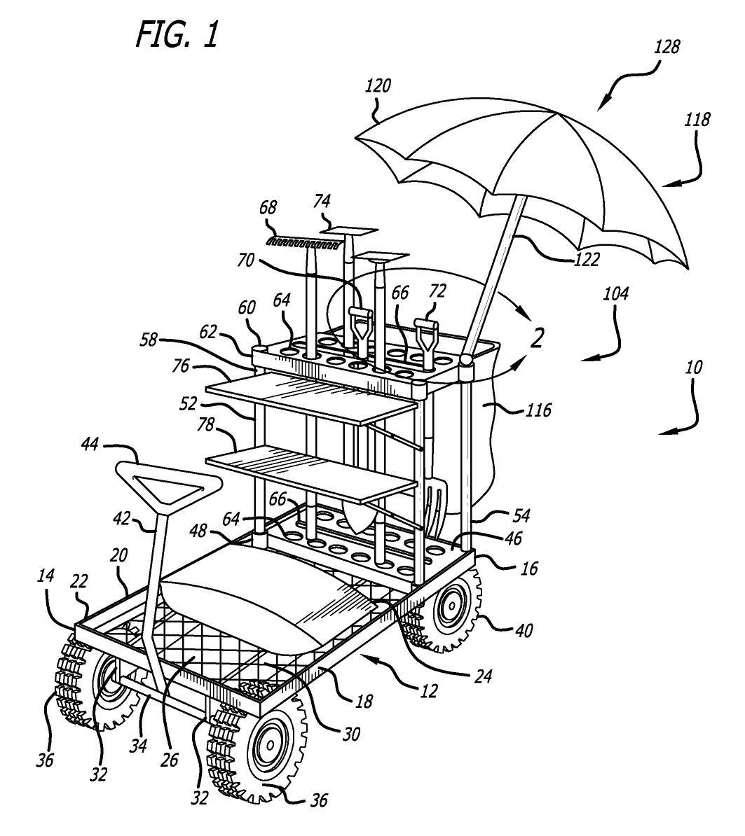

Referring to FIGS. 1-5, in a first embodiment, the garden wagon 10 includes a generally rectangular main body 12, having a front portion 14 and a rear portion 16, left lateral side 18 and right lateral side 20, with raised edges 22 along the front and lateral sides, and a bottom 24. The main body is preferably formed of metal, such as steel or aluminum, for example, although other materials such as a sturdy plastic may also be suitable. The bottom of the main body preferably includes a plurality of apertures 26, such as may be formed by a wire mesh or grid, for example. A pair of longitudinal support beams 30 are typically welded to the bottom of the main body, with axle supports 32 extending transversely from the bottom of the body, and preferably attached to and supported by the longitudinal support beams. Mounted to the bottom of the main body of the garden wagon are front axle 34 with a front pair of wheels 36 rotatably mounted thereto, and a rear axle (not shown) with a rear pair of wheels 40 rotatably mounted thereto. A front pull bar 42 is typically connected at one end to the front axle, with a handle 44 mounted to the other end of the front pull bar.

A rear bottom shelf 46 is disposed on the bottom of the main body, and the rear portions of the lateral sides of the main body include four tubular mounting slots 48, in which four tubular posts, including two front posts 52 and two rear posts 54, are inserted. The upper end portions 56 of the four posts each typically include an enlarged exterior shoulder or flange 58 for receiving and supporting tubular corner slots 60 of a rear top shelf 62. The rear top and bottom shelves preferably include a plurality of corresponding apertures 64 and slots 66 that are aligned vertically, for receiving handles or other portions of a variety of tools, such as a rake 68, spade 70, garden fork 72, hoe 74, and the like.

Referring to FIG. 3, the garden wagon also may include an upper folding tray 76 and a lower folding tray 78, which may be pivotally mounted to the front posts, for holding light loads such as pots, trays of flowers, potted flowers, and the like. Each of the folding trays includes a rectangular top support surface 80 pivotally mounted to the front posts at an upper pivot 82, and at least one folding truss support arm 84 having an upper link 86 and a lower link 88 pivotally connected together in the middle 90 of the truss support arm, and movable between an extended configuration shown in FIGS. 1 and 3-5, supporting the folding tray horizontally and a collapsed, folded configuration (not shown) in which the folding tray is folded down. The upper link of the support arm includes a top end 96 pivotally connected to a front portion 98 of the tray and the lower link of the support arm includes a lower end 100 pivotally connected at a lower pivot 102 to one of the front posts below the corresponding upper pivot of the support arm.

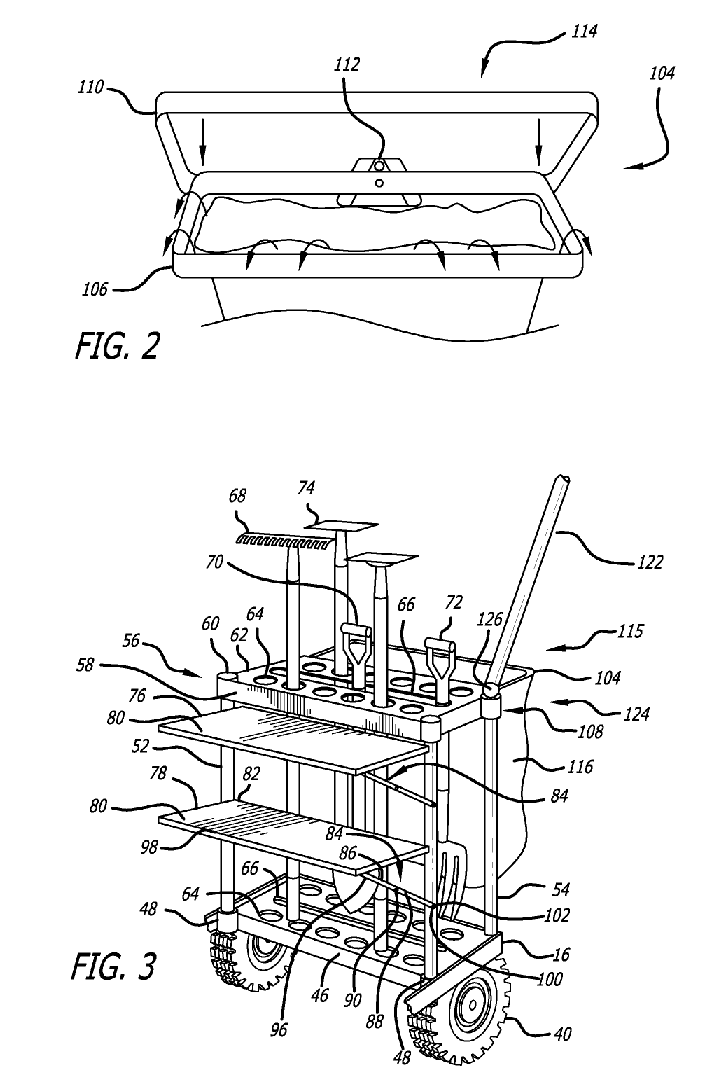

Referring to FIGS. 2 and 3, a generally rectangular trash bag attachment or holder 104 may also be mounted to upper portions of the rear posts of the garden wagon, and the trash bag holder typically has about a 500 lb. load capacity. The trash bag holder includes a lower generally rectangular hoop 106 fixedly mounted to the upper portions 108 of the rear posts, and a slightly larger rectangular pivoting hoop 110 pivotally mounted to the upper portions of the rear posts. The trash bag holder may also be mounted to the rear side of the rear top shelf by a bracket 112. The larger pivoting hoop is movable between a raised position 114, illustrated in FIG. 2, extending above the lower hoop and a lowered position 115 illustrated in FIGS. 1 and 3, extending adjacent to and in close proximity to the lower hoop. The upper hoop can thus be raised to allow the edges of a mouth of a trash bag 116 to be fitted over the lower hoop, and can be lowered the edges of the mouth of the trash bag to be secured over the lower hoop to hold the trash bag open and support the weight of a load in the trash bag.

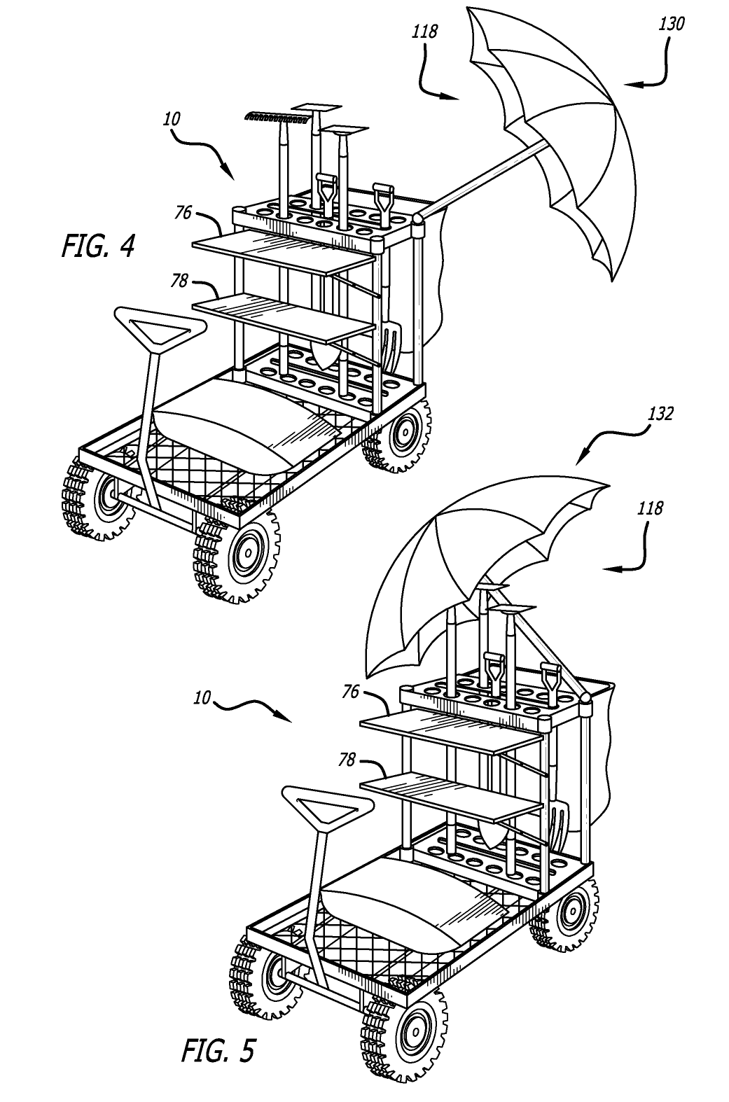

Referring to FIGS. 1 and 3, a sun umbrella 118 having an upper shade portion 120 and a lower support post 122 may also be mounted to the upper end portion of a tubular post. The sun umbrella may advantageously include an adjustable swivel or pivot mounting 124 with a control handle 126 for loosening and tightening the swivel or pivot and adjusting the angle that the shade portion extends from the garden wagon between an elevated, generally upright position 128, shown in FIGS. 1 and 3, and one or more lowered positions 130, 132, illustrated in FIGS. 4 and 5.

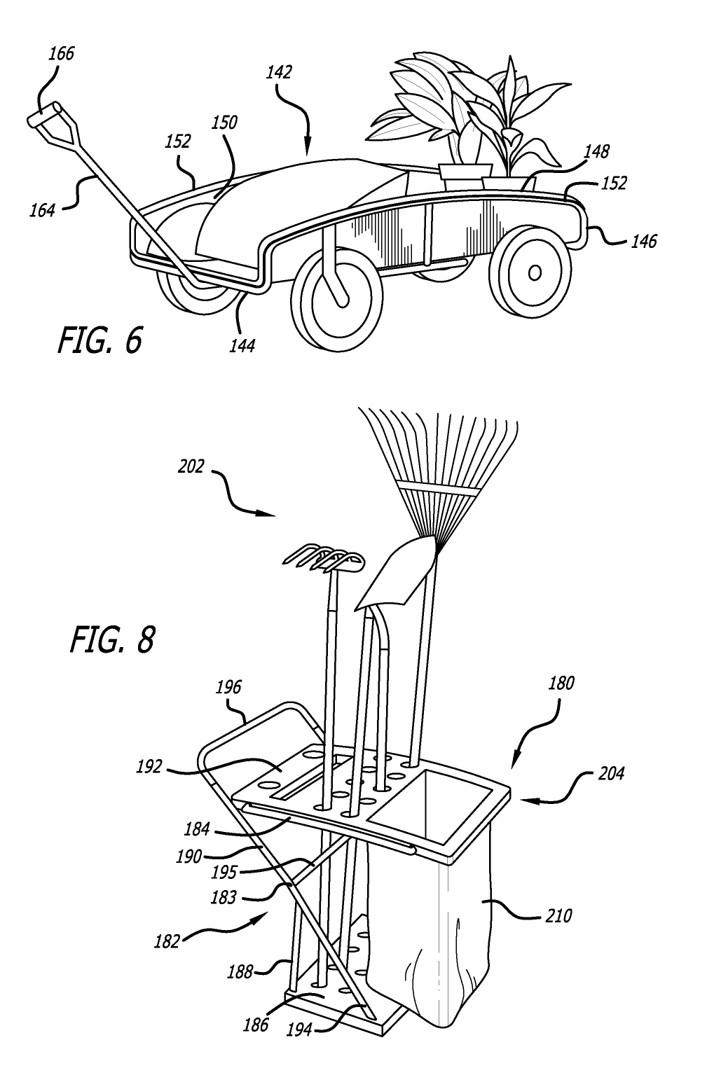

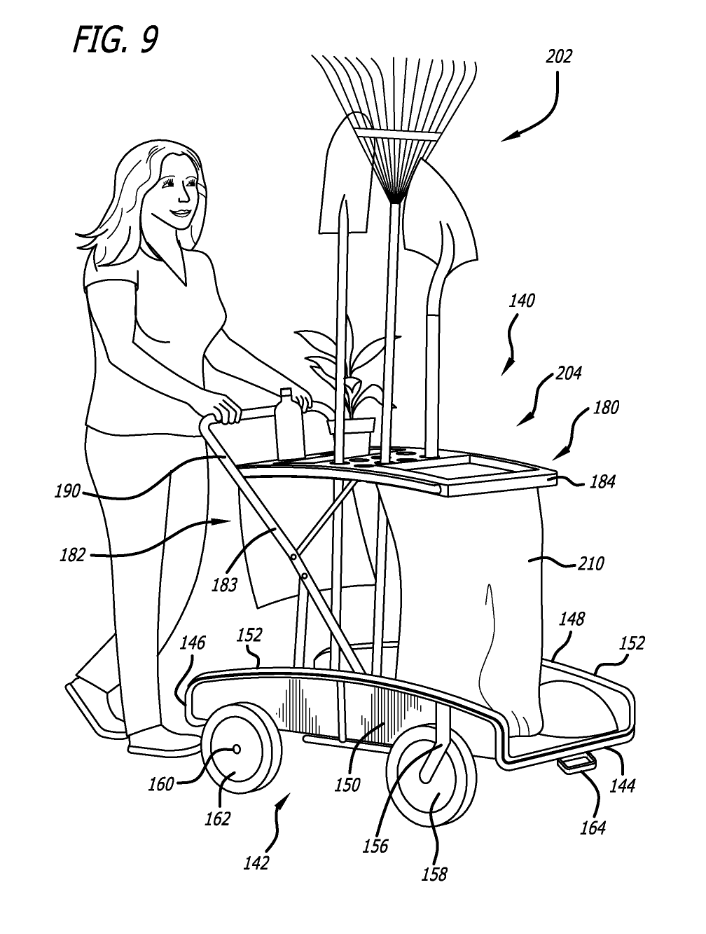

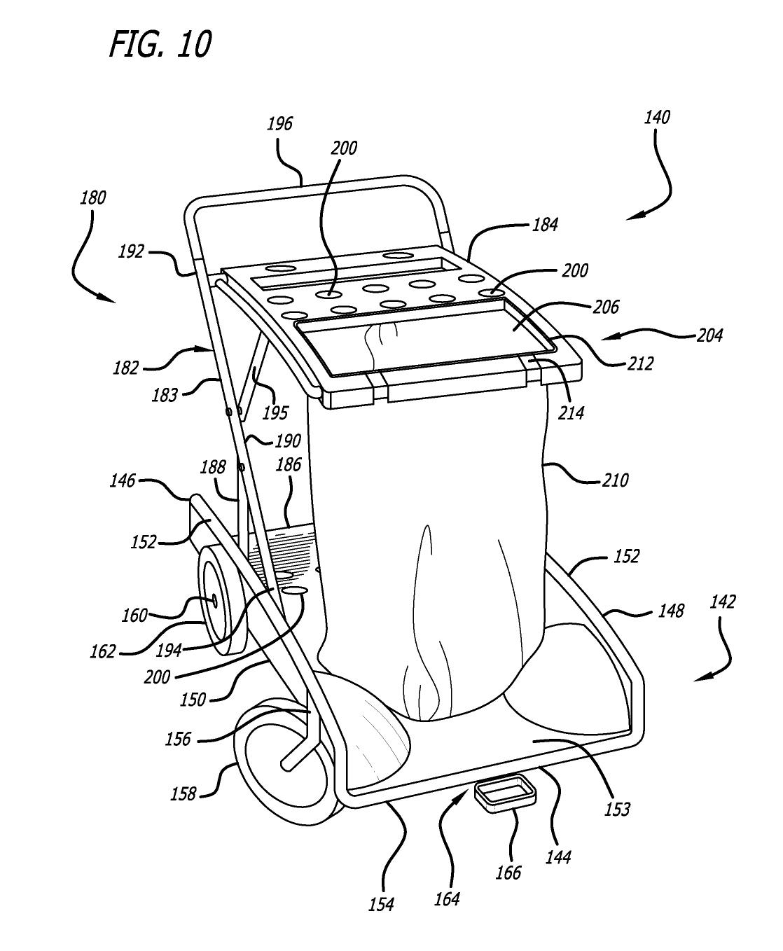

Referring to FIGS. 6-10, in a second preferred embodiment, the garden wagon 140 includes a generally rectangular main body 142, having a front end 144 and a rear end 146, left lateral side 148 and right lateral side 150, with raised edges 152 along the lateral sides, an upper surface 153, and a bottom 154. The main body is preferably formed of metal, such as steel or aluminum, for example, although other materials such as a sturdy plastic may also be suitable. A plurality of wheel supports are typically mounted to the body, such as a front pair of swiveling wheel supports 156, with a front pair of wheels 158 rotatably mounted to the front pair of swiveling wheel supports, and a rear axle 160 mounted to the body, with a rear pair of wheels 162 rotatably mounted to the rear axle.

As is illustrated in FIG. 6, a pull bar 164 having a handle 166 is typically slidably and pivotally connected to the front end of the main body so that it can be stowed under the main body. As is shown in FIG. 7, in a variation of the second embodiment, a rearwardly directed handle 172 may also be mounted to the main body of the garden wagon for pushing the garden wagon. The rearwardly directed handle typically includes a rearwardly directed pair of left and right side elongated handle posts connected to the left and right sides of the main body and having upper ends connected together by a transverse handle member.

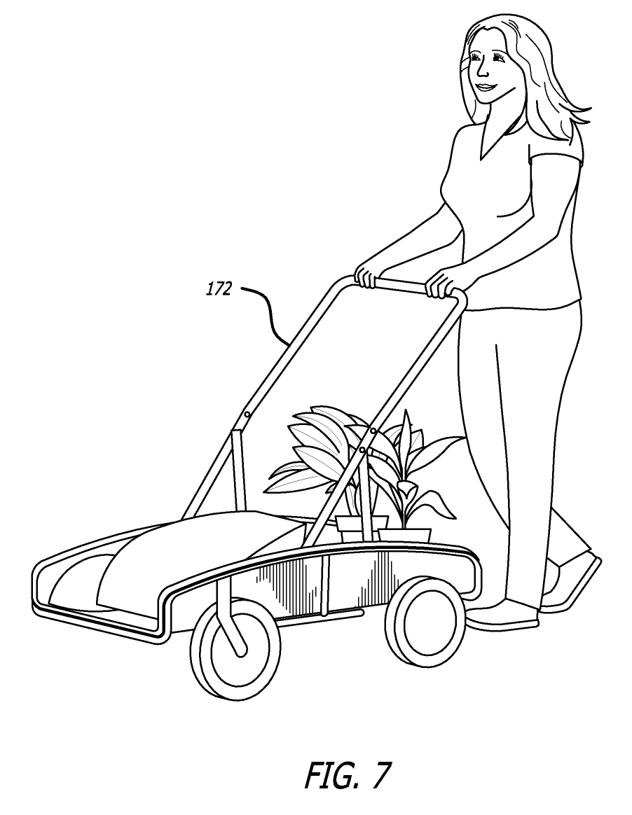

Referring to FIGS. 8-10, in a further aspect, the main body of the garden wagon advantageously can be combined with a modular upper frame assembly 180 that can be removably placed on the upper surface of the main body. The modular upper frame assembly includes a frame 182 of interconnected elongated members 183, a top shelf 184, and a bottom shelf 186 connected together by the frame of interconnected elongated members. The frame of interconnected elongated members typically includes a pair of left and right side generally vertical elongated support brace posts 188 and a rearwardly directed pair of left and right side elongated handle posts 190. The left and right side generally vertical elongated support brace posts having upper ends 192 and bottom ends 194, with the bottom ends of the left and right side generally vertical elongated support brace posts mounted to the left and right lateral sides of the bottom shelf at the rear side of the bottom shelf, and the rearwardly directed pair of left and right side elongated handle posts mounted to left and right lateral sides of the bottom shelf at the front side of the bottom shelf. The rearwardly directed pair of left and right side elongated handle posts are connected to the rear of the top shelf directly, and indirectly by a brace member 195, and are connected to the upper ends of the left and right side generally vertical elongated support brace posts. The rearwardly directed pair of left and right side elongated handle posts upper ends are typically connected together by a transverse handle member 196.

As is illustrated in FIGS. 8-10, the top and bottom shelves also preferably include a plurality of corresponding apertures 200 that are aligned vertically with each other for removably receiving tools 202. The top shelf also typically includes a trash bag holder assembly 204 which includes a trash bag receptacle aperture 206 with a trash bag receptacle hoop (not shown) within the trash bag receptacle aperture for receiving a trash bag 210. A pivoting hoop 212 is typically pivotally mounted to the upper shelf at a location 214 adjacent to the trash bag receptacle aperture. The pivoting hoop is generally slightly larger in diameter than the trash bag receptacle hoop for clamping a portion of the trash bag cooperatively with the trash bag receptacle hoop.

It will be apparent from the foregoing that while particular forms of the invention have been illustrated and described, various modifications can be made without departing from the spirit and scope of the invention. Accordingly, it is not intended that the invention be limited, except as by the appended claims.

1. A garden wagon, comprising:
a generally rectangular main body, having a bottom, front and rear portions, left right lateral sides;
front and rear pairs of wheels rotatably mounted to the bottom of the garden wagon;
a front pull bar with a handle connected to the front of the main body;
a pair of front tubular posts and a pair of rear tubular posts mounted at the rear portion of the bottom of the garden wagon, the front and rear pairs of tubular posts including upper end portions;
a generally rectangular rear top shelf including four tubular corner slots received and supported on said upper end portions of said front and rear pairs of posts; and
a generally rectangular rear bottom shelf disposed on the rear portion of the bottom of the garden wagon.

2. The garden wagon of claim 1, further comprising at least one folding tray pivotally mounted to the front posts.

3. The garden wagon of claim 1, further comprising a trash bag holder mounted to upper portions of the rear posts of the garden wagon.

4. The garden wagon of claim 1, wherein said upper end portions of the front and rear pairs of posts each include an enlarged exterior shoulder for receiving and supporting said tubular corner slots of said rear top shelf.

5. The garden wagon of claim 1, wherein said rear top and bottom shelves include a plurality of corresponding apertures and slots that are aligned vertically for receiving tools.

6. The garden wagon of claim 2, wherein said at least one folding tray comprises an upper folding tray and a lower folding tray.

7. The garden wagon of claim 2, wherein said at least one folding tray includes a rectangular top support surface pivotally mounted to the front posts at an upper pivot, and at least one folding truss support arm having an upper link and a lower link pivotally connected together in the middle of the truss support arm, and said upper link of the support arm includes a top end pivotally connected to a front portion of the tray and the lower link of the support arm includes a lower end pivotally connected at a lower pivot to one of the front posts below the corresponding upper pivot of the support arm, wherein said upper and lower links of the support arm are movable between an extended configuration supporting the folding tray horizontally and a collapsed, folded configuration in which the folding tray is folded down.

8. The garden wagon of claim 3, wherein said trash bag holder comprises a lower generally rectangular hoop fixedly mounted to the upper portions of the rear posts, and a slightly larger rectangular pivoting hoop pivotally mounted to the upper portions of the rear posts.

9. The garden wagon of claim 1, wherein said trash bag holder is mounted to the rear side of the rear top shelf by a bracket.

10. The garden wagon of claim 6, wherein said larger pivoting hoop is movable between a raised position extending above the lower hoop and a lowered position extending adjacent to and in close proximity to the lower hoop.

11. The garden wagon of claim 1, further comprising a sun umbrella having an upper shade portion and a lower support post, said lower support post being mounted to the upper end portion of one of said tubular posts.

12. The garden wagon of claim 1, wherein said sun umbrella comprises an adjustable pivot mounting with a control handle for moving said shade portion between an elevated, generally upright position and a lowered position.

13. A garden wagon, comprising:
a generally rectangular main body, having a bottom, front and rear portions, left right lateral sides;
front and rear pairs of wheels rotatably mounted to the bottom of the garden wagon; and
a modular upper frame assembly removably disposed on the upper surface of the main body.

14. The garden wagon of claim 13, further comprising a pull bar slidably and pivotally connected to one end of said main body.

15. The garden wagon of claim 13, further comprising a rearwardly directed handle including a rearwardly directed pair of left and right side elongated handle posts connected to said main body and having upper ends connected together by a transverse handle member.

16. The garden wagon of claim 13, wherein said modular upper frame assembly comprises:
a frame of interconnected elongated members; and
a top shelf and a bottom shelf connected together by said frame of interconnected elongated members.

17. The garden wagon of claim 16, wherein said frame of interconnected elongated members includes a pair of left and right side elongated support brace posts and a rearwardly directed pair of left and right side elongated handle posts, the left and right side elongated support brace posts having upper ends and bottom ends, the bottom ends of the left and right side elongated support brace posts being mounted to the left and right lateral sides of the bottom shelf at the rear side of the bottom shelf, the rearwardly directed pair of left and right side elongated handle posts being mounted to left and right lateral sides of the bottom shelf at said front side of said bottom shelf, and said rearwardly directed pair of left and right side elongated handle posts being connected to said upper ends of said left and right side elongated support brace posts.

18. The garden wagon of claim 17, wherein said rearwardly directed pair of left and right side elongated handle posts have upper ends connected together by a transverse handle member.

19. The garden wagon of claim 16, wherein said top and bottom shelves include a plurality of corresponding apertures and slots that are aligned vertically with each other for receiving tools.

20. The garden wagon of claim 16, wherein said top shelf comprises a trash bag holder assembly.
